(19) United States
(12) Patent Application Publication
(10) Pub. No.: US 2026/0143521 A1
(43) Pub. Date: May 21, 2026

(54) SEMI-PERSISTENT MULTI-AP COORDINATION

(71) Applicant: TELEFONAKTIEBOLAGET LM ERICSSON (PUBL), Stockholm (SE)

(72) Inventors: Charlie Pettersson, SOLNA (SE); Abhishek AMBEDE, HUDDINGE (SE); Rocco DI TARANTO, LUND (SE); Sebastian MAX, COLOGNE (DE)

(21) Appl. No.: 19/121,396

(22) PCT Filed: Nov. 10, 2022
(86) PCT No.: PCT/EP2022/081536

§ 371 Date: Apr. 15, 2025

(51) Int. Cl. H04W 74/04; H04W 56/00; H04W 84/12

(52) U.S. Cl. CPC H04W 74/04; H04W 56/001; H04W 84/12

(57) ABSTRACT

Systems and methods are disclosed for setup and use of a semi-persistent Multi-Access Point (MAP) agreement for MAP coordination in a Wireless Local Area Network (WLAN). In one embodiment, a method performed by a first WLAN Access Point (AP) comprises communicating with at least one second WLAN AP for setup of a semi-persistent MAP agreement that defines a plurality of MAP periods in which coordinated MAP operation between the first WLAN AP and the at least one second WLAN AP is to occur. The method further comprises operating in accordance with the semi-persistent MAP agreement. The semi-persistent MAP agreement is such that both the first WLAN AP and the at least one second WLAN AP are permitted to transmit during each of the plurality of MAP periods in accordance with the semi-persistent MAP agreement.

### TECHNICAL FIELD

The present disclosure relates to a Wireless Local Area Network (WLAN) and, more specifically, to Multi-Access Point (MAP) coordination in a WLAN.

### BACKGROUND

In the standardization discussions undertaken in the Institute for Electronics and Electrical Engineers (IEEE) IEEE 802.11 task group (TG) “be”, Multi-Access Point (MAP) coordination was one of the candidate features for the amendment. However, over the lifetime of the TG, the feature was down-prioritized and eventually dropped. The MAP coordination feature is again being discussed as a potential candidate for the Ultra High Reliability (UHR) study group, which is destined to become the next major IEEE 802.11 amendment task group.

MAP coordination assumes that system performance can be improved if the Access Points (APs) within a limited area coordinate their transmissions instead of working independently. So far, discussions of different variants of the same coordination feature have been seen from many active companies. However, all the proposals only discuss the coordination of the APs for the duration of a single transmit window, which can be either a full Physical layer Protocol Data Unit (PPDU) or a single Transmit Opportunity (TXOP).

A brief discussion of some of the techniques that may be used for MAP coordination is as follows. Some of these techniques have been discussed previously for a single TXOP/PPDU and some have not been discussed but may become more attractive in the future. Some MAP coordination techniques are:
Coordinated Spatial Reuse (CSR): CSR coordinates transmit (Tx) power between different APs such that proper spatial reuse may be achieved
Coordinated Beamforming (CBF): CBF is a technique where each device steers nulls in certain direction(s) to eliminate interference at the respective receivers.
Coordinated Orthogonal Frequency Division Multiple Access (C-OFDMA) and Coordinated Time Division Multiple Access (C-TDMA): C-OFDMA and C-TDMA are techniques in which time and/or frequency resources are divided between the devices, rather than reused by different devices, such that a lower channel access delay may be achieved at a small cost of overhead.
Synchronized Uplink (UL)/Downlink (DL) Direction: Synchronizing the UL/DL transmissions of the devices is an attractive technique as it is easier to predict downlink interference rather than uplink interference due to the mobility of wireless stations (STAs).
Different Multi-Links and/or Channel Assignments: This is a technique that provides a way to agree about sharing or not sharing resources between different devices.
Cooperative OFDMA: Cooperative OFDMA is a technique where multiple APs transmit to the same STAs but on different resources (e.g., different Resource Units (RUS)), which may be appealing for reliability purposes.
Joint Transmission: Joint transmission is a technique which allows multiple APs to jointly transmit to the same STA to increase throughput.

One of the features introduced in IEEE 802.11ax is Target Wake Time (TWT). TWT is a feature that allows an AP to schedule activity in its Basic Service Set (BSS). Initially, TWT was designed and introduced to reduce the required amount of time that a STA utilizing a power management mode needs to be awake. A TWT agreement allows an AP to schedule transmission to/from STAs possibly at non-overlapping times, and therefore bundles the frame exchanges to such STAs in predefined Service Periods (SPs). Furthermore, the bundling also serves the purpose to reduce contention between STAs, as the number of simultaneous active STAs is lowered by separating them into different SPs of different TWT agreements.

TWT SPs may be set up in two different ways, either by performing individual TWT agreements between the AP and each STA or by the AP announcing the TWT agreement its beacon frame, in which case the TWT agreement is referred to as a broadcast TWT agreement. Broadcast TWT agreements indicate when an SP is scheduled and which member STAs should be prepared to participate. It is important to point out that, in both cases, these are agreements and, even though an AP can force a TWT capable STA to either join a broadcast TWT agreement or setup an individual agreement, the STA is allowed to immediately teardown the agreement. To support these negotiations, there are several options that can be signaled between devices to reach a TWT agreement that is satisfactory to all of the involved devices.

Furthermore, an SP may be terminated by an AP if it is no longer required for delivering the member data. This could either be due to overprovisioning (e.g., because in a certain transmission a more robust Modulation and Coding Scheme (MCS) than expected is used), or due to that the traffic expected to arrive at a certain point of time has not arrived.

It should be noted that the TWT mechanism only guarantees that STAs will wake up at the agreed time, and it does not prevent STAs from waking up and contending for channel access at any other point in time. To avoid this, the AP needs to set up the Multi-User (MU) Enhanced Distributed Channel Access (EDCA) parameters in the STAs by selecting access parameters that effectively prevent the STAs from contending. By doing so, the AP may create a controlled environment in its BSS (UL transmissions may be triggered with Trigger Frames (TFs)) when no legacy STAs (not supporting the MU EDCA parameter setting) are present.

IEEE TG be introduced restricted TWT (r-TWT) which builds upon the same principle of scheduling STAs but also provides means for increased protection of the SPs. This is because with r-TWT the AP can further prioritize certain latency sensitive traffic flows within the SP. The details of such prioritization mechanism are currently “To Be Determined” in the draft amendment for IEEE 802.11.

To protect the SP from other devices trying to access the medium,
1. A scheduling AP may signal a quiet interval with the same start time as the SP with a duration of 1 time unit (1 TU=1024 μs).
2. r-TWT capable non-AP STAs shall ensure that their ongoing TXOP end before any upcoming r-TWT SP advertised by the associated AP. Similarly, if they are not a member of an upcoming r-TWT SP, they cannot start new data transmissions that will not finish before the r-TWT SP starts as well.

Contrary to 802.11ax TWT, IEEE 802.11be r-TWT only allows broadcast agreements for setting up SPs. These agreements set up periodic SPs.

### SUMMARY

Systems and methods are disclosed for setup and use of a semi-persistent Multi-Access Point (MAP) agreement for MAP coordination in a Wireless Local Area Network (WLAN). In one embodiment, a method performed by a first WLAN Access Point (AP) comprises communicating with at least one second WLAN AP for setup of a semi-persistent MAP agreement that defines a plurality of MAP periods in which coordinated MAP operation between the first WLAN AP and the at least one second WLAN AP is to occur. The method further comprises operating in accordance with the semi-persistent MAP agreement. The semi-persistent MAP agreement is such that both the first WLAN AP and the at least one second WLAN AP are permitted to transmit during each of the plurality of MAP periods in accordance with the semi-persistent MAP agreement. By using a semi-persistent MAP agreement, the amount of overhead needed to setup each transmit opportunity or MAP period may be minimized. Not only that, but by also having a semi-persistent MAP agreement that lasts longer in time, APs may use this information to make better scheduling decisions and prioritize data flows accordingly.

In one embodiment, the plurality of MAP periods are independent from Service Periods (SPs) for a Target Wake Time (TWT) or restricted TWT (r-TWT) mechanism utilized by at least one of the first WLAN AP and the at least one second WLAN AP.

In one embodiment, the coordinated MAP operation comprises: operation to provide Coordinated Spatial Reuse (CSR) which coordinates transmit power between different APs such that spatial reuse can be achieved; operation to provide coordinated beamforming where nulls are placed in directions that mitigate or eliminate interference at respective receivers; operation to provide Coordinated Orthogonal Frequency Multiple Access (C-OFDMA) or Coordinated Time Division Multiple Access (C-TDMA), where frequency or time resources are divided among the first WLAN AP and the at least one second WLAN AP; operation to provide synchronized transmission direction for the first WLAN AP and the at least one second WLAN AP; operation to provide coordinated use of multi-links and/or channel assignments by the first WLAN AP and the at least one second WLAN AP; operation to provide Cooperative-OFDMA where the first WLAN AP and the at least one second WLAN AP transmit to a same wireless station, STA, but on different resources; operation to provide coordinated joint transmission to a same wireless STA; operation to provide coordinated quiet intervals; or operation to provide prioritization of specific data flows.

In one embodiment, a type of coordinated MAP operation in one MAP period of the plurality of MAP periods is different than a type of coordinated MAP operation in another MAP period of the plurality of MAP periods.

In one embodiment, communicating with the at least one second WLAN AP for setup of the semi-persistent MAP agreement comprises transmitting the MAP agreement to the at least one second WLAN AP. In one embodiment, communicating with the at least one second WLAN AP for setup of the semi-persistent MAP agreement further comprises receiving an acceptance of the MAP agreement from the at least one second WLAN AP.

In one embodiment, communicating (300) with the at least one second WLAN AP for setup of the semi-persistent MAP agreement comprises transmitting and receiving messages to and from the at least one second WLAN AP for negotiation of the MAP agreement; and receiving an acceptance of the MAP agreement, as negotiated by the messages.

In one embodiment, the plurality of MAP periods defined by the semi-persistent MAP agreement are periodic.

In one embodiment, the semi-persistent MAP agreement comprises one or more timing parameters that define timing of the plurality of MAP periods. In one embodiment, the one or more timing parameters comprise: (a) a periodicity of the plurality of MAP periods, (b) a time duration of each MAP period, (c) a persistence length for the semi-persistent MAP agreement, or (d) a combination of any two or more of (a)-(c).

In one embodiment, the semi-persistent MAP agreement further comprises: (i) information about whether a MAP period may be initiated only by an initiating AP that initiated setup of the semi-persistent MAP agreement where the initiating AP is an AP from among the first WLAN AP and the at least one second WLAN AP, (ii) information about whether a MAP period may be initiated by any of the first WLAN AP and the at least one second WLAN AP, (iii) information about whether any information or parameters need to be collected or updated before or at a start of a MAP period, or (iv) a combination of any two or more of (i)-(iii).

In one embodiment, at least one of the plurality of MAP periods comprises at least one Service Period (SP) for a Target Wake Time (TWT) or restricted TWT (r-TWT) feature.

In one embodiment, at least one of the plurality of MAP periods comprises at least two SPs for a TWT or r-TWT feature. In one embodiment, the MAP coordination within the at least one of the plurality of MAP periods is based on prioritization between the at least two SPs or prioritization of data belonging to the at least two SPs. In one embodiment, the prioritization is based on which of the at least two SPs started first or which of the data belonging to the at least two SPs arrived first, which of the at least two SPs has a lowest duration or which of the at least two SPs for which the data has a lowest latency bound, or which of the at least two SPs has a least amount of time before it ends or which of the at least two APs for which the data has a least amount of time remaining until its latency bound. In one embodiment, at least one parameter defined by the semi-persistent MAP agreement can be changed within a SP and not for a corresponding MAP period. In one embodiment, communicating with the at least one second WLAN AP for setup of the semi-persistent MAP agreement comprises communicating with the at least one second WLAN AP for setup of the semi-persistent MAP agreement via a broadcast TWT agreement framework.

In one embodiment, the method further comprises further communicating with the at least one second WLAN AP about initiation of a MAP period from among the plurality of MAP periods. In one embodiment, further communicating with the at least one second WLAN AP about initiation of the MAP period comprises dynamically adapting at least one parameter of the semi-persistent MAP agreement for the initiated MAP period. In one embodiment, one or more restrictions on the dynamically adapting are defined in the semi-persistent MAP agreement. In one embodiment, the one or more restrictions comprise a restriction on which parameters can be dynamically adapted. In one embodiment, the one or more restrictions comprise a restriction on how one or more parameters can be dynamically adapted.

In one embodiment, initiation of the MAP coordination within a MAP period is signaled by one of the first and at least one second WLAN APs.

Corresponding embodiments of the first WLAN AP are also disclosed. In one embodiment, a first WLAN AP is adapted to communicate with at least one second WLAN AP for setup of a semi-persistent MAP agreement that defines a plurality of MAP periods in which coordinated MAP operation between the first WLAN AP and the at least one second WLAN AP is to occur. The first WLAN AP is further adapted to operate in accordance with the semi-persistent MAP agreement. Both the first WLAN AP and the at least one second WLAN AP are permitted to transmit during each of the plurality of MAP periods in accordance with the semi-persistent MAP agreement.

In one embodiment, a first WLAN AP comprises one or more transmitters, one or more receivers, and processing circuitry associated with the one or more transmitters and the one or more receivers. The processing circuitry is configured to cause the first WLAN AP to communicate with at least one second WLAN AP for setup of a semi-persistent MAP agreement that defines a plurality of MAP periods in which coordinated MAP operation between the first WLAN AP and the at least one second WLAN AP is to occur. The processing circuitry is further configured to cause the first WLAN AP to operate in accordance with the semi-persistent MAP agreement. Both the first WLAN AP and the at least one second WLAN AP are permitted to transmit during each of the plurality of MAP periods in accordance with the semi-persistent MAP agreement.

In one embodiment, a non-transitory computer-readable medium is provided, where the non-transitory computer-readable medium stores instructions executable by processing circuitry of a first WLAN AP, whereby the first WLAN AP is caused to communicate with at least one second WLAN AP for setup of a semi-persistent MAP agreement that defines a plurality of MAP periods in which coordinated MAP operation between the first WLAN AP and the at least one second WLAN AP is to occur and operate in accordance with the semi-persistent MAP agreement. Both the first WLAN AP and the at least one second WLAN AP are permitted to transmit during each of the plurality of MAP periods in accordance with the semi-persistent MAP agreement.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates two examples where Target Wake Time (TWT) or restricted TWT (r-TWT) Service Periods (SPs) between two different Access Points (APs) are uncoordinated which may potentially lead to harmful interference between the two APs;

FIG. 2 illustrates one example of a Wireless Local Area Network (WLAN) that includes multiple APs that setup and operate in accordance with semi-persistent Multi-AP (MAP) agreements in accordance with embodiments of the present disclosure;

FIG. 3 illustrates the operation of a set of APs to setup and operate in accordance with a semi-persistent MAP agreement in accordance with one embodiment of the present disclosure;

FIG. 4 illustrates one example of semi-persistent MAP coordination in accordance with one embodiment of the present disclosure;

FIG. 5 illustrates another example of semi-persistent MAP coordination in which the start of any subsequent MAP periods may be initiated by any of the participating APs, in accordance with one embodiment of the present disclosure;

FIG. 6 illustrates example of initial step of a semi-persistent MAP agreement and operation in accordance therewith within a MAP period when the MAP period completely coincides with a SP belonging the responding AP, in accordance with one embodiment of the present disclosure;

FIG. 7 illustrates an example of what the semi-persistent coordination may look like within a single MAP period when the period is longer in time than the SP has been set up for, in accordance with another embodiment of the present disclosure;

FIG. 8 illustrates an example similar to that of FIG. 6 but where, due to delayed channel access in the MAP period, the initiating AP only decides to support the member data of the SP, in accordance with another embodiment of the present disclosure;

FIG. 9 illustrates an example where the MAP period agreed upon in the initial setup covers the duration of both a first SP (SP 1) and a second SP (SP 2), in accordance with another embodiment of the present disclosure;

FIG. 10 illustrates another example of a MAP period that covers two or more SPs from different coordinating APs and how this may be handled via the semi-persistent MAP agreement, in accordance with another embodiment of the present disclosure;

FIG. 11 illustrates an example in which an AP that sets up a broadcast TWT agreement in its beacon simultaneously indicates that a second AP is free to also transmit to its station (STA) using Cooperative Orthogonal Frequency Division Multiple Access (OFDMA) to provide better reliability, in accordance with another embodiment of the present disclosure; and

FIG. 12 is a schematic block diagram of an example embodiment of an AP in which embodiments of the present disclosure may be implemented.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

As discussed in the Background section above, in the new IEEE study group (SG) Ultra High Reliability (UHR), there have been discussions on improving reliability, lowering latency, improving handover, and increasing throughput. As a result, MAP coordination is being considered as a candidate feature for IEEE 802.11. In this regard, it would be attractive to also use the MAP coordination feature for further increasing the protection of Target Wake Time (TWT) and restricted TWT (r-TWT) Service Periods (SPs).

During IEEE 802.11 SG UHR telephone calls held in September 2022, some contributions related to the systems and methods described herein were presented. Specifically, the contribution IEEE 802.11-22/1530r1, “Multi AP coordination for next generation Wi-Fi”, by delegates affiliated with Samsung Research, September 2022 (hereinafter referred to as the “Contribution by Delegates Affiliated with Samsung”) illustrates how coordination among APs can benefit Wi-Fi operation especially when done in the time domain. The fundamental idea in the Contribution by Delegates Affiliated with Samsung is that neighboring Access Points (APs) can share TWT information of their Basic Service Set (BSS) to reduce Overlapping Basic Service Set (OBSS) interference experienced by the wireless stations (STAs). For r-TWT operation for example, an AP may ask a neighbor AP to quiet transmission in a neighbor AP's BSS during the r-TWT interval.

The solutions proposed herein are different from those described in the Contribution by Delegates Affiliated with Samsung in several aspects. One central aspect is that the systems and methods described herein are dynamic, i.e., even if the MAP agreements described herein are semi-persistent, i.e., they are initially setup and hold for a certain interval of time, each time a MAP period is actually reserved, a re-setup frame is sent by one AP. Such a re-setup frame allows for a high degree of flexibility in the proposed scheme in that the amount of traffic, the nature of traffic, the set of devices allowed to transmit etc. is changed depending on exactly when a certain MAP period is available with respect to the planned time. Furthermore, another option for minor renegotiation of operating parameters for the MAP agreement may be allowed in subsequent re-setup frames. The parameter(s) that can be dynamically adapted in this manner and/or the degree to which the parameter(s) may be adapted is, in one embodiment, agreed upon during initial setup of the MAP agreement. The solutions in the Contribution by Delegates Affiliated with Samsung are instead static, i.e., an exchange of information between APs happens before the actual transmissions start and then a certain level of protection is obtained based on that. The issue of delayed channel access is not considered at all in the Contribution by Delegates Affiliated with Samsung.

Furthermore, in some embodiments, the systems and methods disclosed herein allow flexibility in selecting the type of MAP coordination used across APs during an SP while the Contribution by Delegates Affiliated with Samsung only provides a means for protecting transmissions during an SP with a fixed coordination mechanism across APs. In certain cases, it may be more beneficial for the APs to change the MAP coordination mechanism rather than to try to increase protection with the current MAP coordination mechanism. Let us for example consider the case where several APs have setup a MAP agreement, each AP has a number of scheduled r-TWT periods, and some r-TWT periods overlap across several BSSs. By using the solutions in the Contribution by Delegates Affiliated with Samsung, providing overall protection is a very hard task and becomes more and more difficult when the number of APs increases because each AP needs to make a sacrifice to protect the transmissions of other APs. On the other hand, in some embodiments of the present disclosure, the AP may rather decide to change the MAP coordination mechanism and, for example, decide to switch to a Coordinated Orthogonal Frequency Division Multiple Access (C-OFDMA) scheme which would allow them to operate on orthogonal frequency resources at the same time. Depending on the actual conditions, APs may also decide to use another MAP coordination mechanism that fit betters to those actual conditions.

IEEE 802.11-22/1556r1, “Multi AP Coordination for Low Latency Traffic Delivery”, by delegates affiliated with Oppo, September 2022 (hereinafter referred to as the “Contribution by Delegates Affiliated with Oppo”) proposes a mode with a) enhanced medium access protection, b) sharing of reserved resources, and c) sharing of interfering STAs in order to reduce latency of critical traffic in multi-AP scenarios. While the overall goal in the Contribution by Delegates Affiliated with Oppo is similar to that in the Contribution by Delegates Affiliated with Samsung, a completely new protocol is presented in the Contribution by Delegates Affiliated with Oppo, and this new protocol does not rely on existing IEEE 802.11be features like TWT and r-TWT. This as well as other aspects makes embodiments of the solution proposed herein different from those presented in the Contribution by Delegates Affiliated with Oppo.

Semi-persistent scheduling is available in 3GPP technologies such as, for example, 4^{th} Generation (4G)/Long Term Evolution (LTE), LTE Advanced (LTE-A), and 5^{th} Generation (5G) technologies. In these 3GPP technologies, Semi-Persistent Scheduling (SPS)-based resource allocation refers to a transmission mode in which the serving base station allocates at least a part of resources and transport formats to a User Equipment (UE) semi-persistentally over a certain time interval consisting of a number of Transmission Time Intervals (TTIs). In the downlink, SPS is configured by Radio Resource Control (RRC) signal per serving cell and per bandwidth part (BWP). Multiple configurations can be active simultaneously on different serving cells. Activation and deactivation of the downlink SPS transmissions are independent among the serving cells. While 3GPP SPS is strictly related to the semi-persistent multi-AP coordination disclosed herein, there are several additional aspects to consider when operating in unlicensed bands such as those in which IEEE 802.11 networks operate. A fundamental difference is, for example, that in 3GPP once the scheduling is decided by the base station, then it is always possible to make sure that the transmissions occur as planned as operations happen in licensed bands where there is always a guarantee to have a channel available when needed and planned. This is not the case in unlicensed bands. Even if the IEEE 802.11 APs agreed on a certain coordination, there is not a guarantee that they will be able to operate when planned. Because of this, in IEEE 802.11 networks, further mechanism are needed to account for this unpredictability. This as well as other aspects make embodiments of the present disclosure novel with respect to SPS used in 3GPP technologies.

There are certain challenges with existing MAP coordination technologies. If a set of two or more APs agree on cooperating, a setup procedure needs to be performed which results in overhead. Moreover, by not knowing if coordination will be possible in the future, the ability of the APs to plan and make good scheduling decisions is limited.

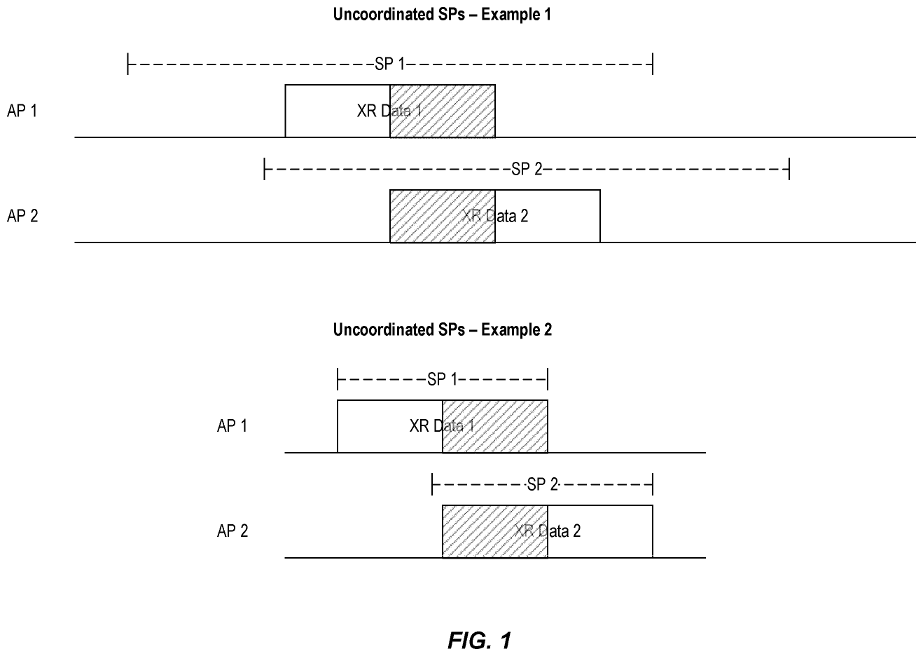

Furthermore, by not allowing multi-AP coordinating APs to also coordinate their operation during r-TWT SPs, their operation may result in decreased reliability in periods where reliability might be essential. In this regard, FIG. 1 illustrates two examples where SPs between two different APs are uncoordinated which may potentially lead to harmful interference between the two APs. The top part of FIG. 1 shows an example where longer SPs time resources than needed are reserved with respect to the actual traffic to deliver, and the bottom part of FIG. 1 shows an example the time durations of the SPs is exactly equal to the amount of time needed to deliver the actual traffic.

Additionally, the TWT and r-TWT mechanisms are designed for optimal operations in controlled environments where a device, typically the AP, is always guaranteed to reserve a TXOP at a certain point of time. While it is likely that in many situations it may be possible to have a controlled environment by proper channel planning and in absence of legacy devices, this will not always be the case. There is therefore a need to provide means for APs to handle situations wherein channel access may not be possible exactly when it is desired.

Systems and methods are disclosed herein that provide solutions to the aforementioned and/or other challenges. Embodiments are disclosed that provide a framework for multiple nearby APs to set up a semi-persistent MAP agreement for cooperation that is valid for longer periods of time. The semi-persistent MAP agreement defines multiple MAP periods in which coordinated MAP operation between the APs is to occur. In one embodiment, the MAP coordination for the MAP periods is defined by the semi-persistent MAP agreement such that all of the APs that are included in the MAP agreement can transmit, if desired, in each MAP period. In one embodiment, the MAP periods are independent from TWT/r-TWT SPs (e.g., independently configured, may have different lengths, may have different start times, may have different end times, may have different periodicities, etc.). Further, in one embodiment, one or more parameters of the semi-persistent MAP agreement may be dynamically updated, e.g., at initiation of each MAP period.

While not being limited to or by any particular advantage, embodiments of the solutions disclosed herein may provide a number of advantages over existing technology. By using a semi-persistent MAP agreement, the amount of overhead needed to setup each MAP period may be minimized. Not only that, but by also having a semi-persistent MAP agreement that lasts longer in time, APs may use this information to perform better scheduling decisions and prioritize data flows accordingly.

Furthermore, by coordinating their SPs that occur within the MAP periods, better protection for the data delivered within an r-TWT SP may be provided, which is one of the primary goals of the IEEE UHR SG. Also, by reducing unnecessary uncontrolled interference, retransmissions are less likely and, as a result, important latency improvements may also be possible.

By using embodiments of the present disclosure, it may be possible to take advantage of TWT and r-TWT mechanisms in environments that are not completely controlled, i.e., where it may not be guaranteed that APs would be able to reserve the channel at the time they have planned and agreed.

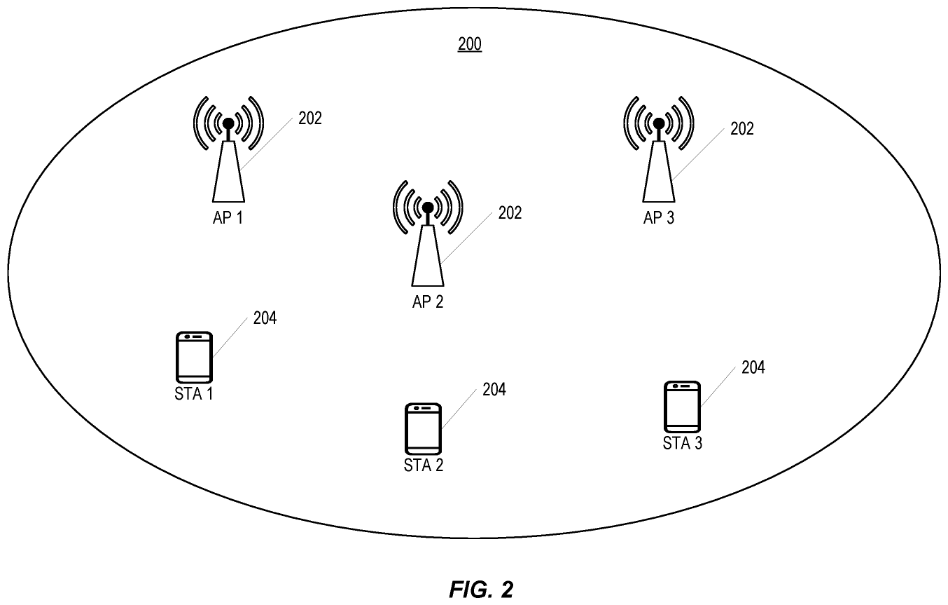

In this regard, FIG. 2 illustrates one example of a Wireless Local Area Network (WLAN) 200 that includes multiple APs 202 that setup and operate in accordance with semi-persistent MAP agreements in accordance with embodiments of the present disclosure. As illustrated, the WLAN 200 includes APs 202 and wireless stations (STAs) 204 that transmit and receive wireless signals between one another in accordance with the IEEE 802.11 protocol. As described herein, the APs 202 communicate with one another to setup a semi-persistent MAP agreement and then operate in accordance with the semi-persistent MAP agreement. The semi-persistent MAP agreement defines multiple MAP periods during which coordinated MAP operation is provided between the APs 202. By defining the MAP periods semi-persistently, the MAP periods may be scheduled (e.g., periodically) as often as they may be desired, which the cooperating APs 202 will agree upon. The intention with the MAP periods is that channel access is performed as normal within the MAP period, and this is not a means to gain prioritized access. The semi-persistent MAP periods provide a means for the collaborating APs Q012 to plan further into the future which may both reduce overhead as well as help the collaborating APs 202 to prioritize data and schedule more effectively.

In one embodiment, MAP agreement includes one or more timing parameters that define the MAP periods. For example, in one particular embodiment, the MAP periods are periodic and occur at a periodicity that is, e.g., defined as part of the semi-persistent MAP agreement. The semi-persistent MAP agreement may also define other timing parameters such as, e.g., a duration of a MAP period (e.g., a single duration may be defined as the duration of all of the MAP periods). The semi-persistent MAP agreement may also define one or more non-timing related parameters such as, e.g., a coordinated MAP technique to be used during the MAP periods, which AP(s) an initiate (i.e., initiate use of) a MAP period, etc. Further, in one embodiment, the semi-persistent MAP agreement may be dynamically adapted, e.g., at initiation of each MAP period. In this regard, the semi-persistent MAP agreement may further include parameters that define one or more restrictions on how the semi-persistent MAP agreement can be dynamically adapted (e.g., which AP(s) can adapt parameter(s) of the semi-persistent MAP agreement, which parameter(s) of the semi-persistent MAP agreement can be adapted, a degree to which or how parameter(s) of the semi-persistent MAP agreement can be adapted, etc.). In one embodiment, the APs 202 also utilize the IEEE 802.11 TWT feature and/or r-TWT feature, and the MAP periods are independent of the (r-)TWT SPs (e.g., independently configured, may have different lengths, may have different start times, may have different end times, may have different periodicities, etc.). In one embodiment, at least one of the MAP periods includes a (r-)TWT SP(s).

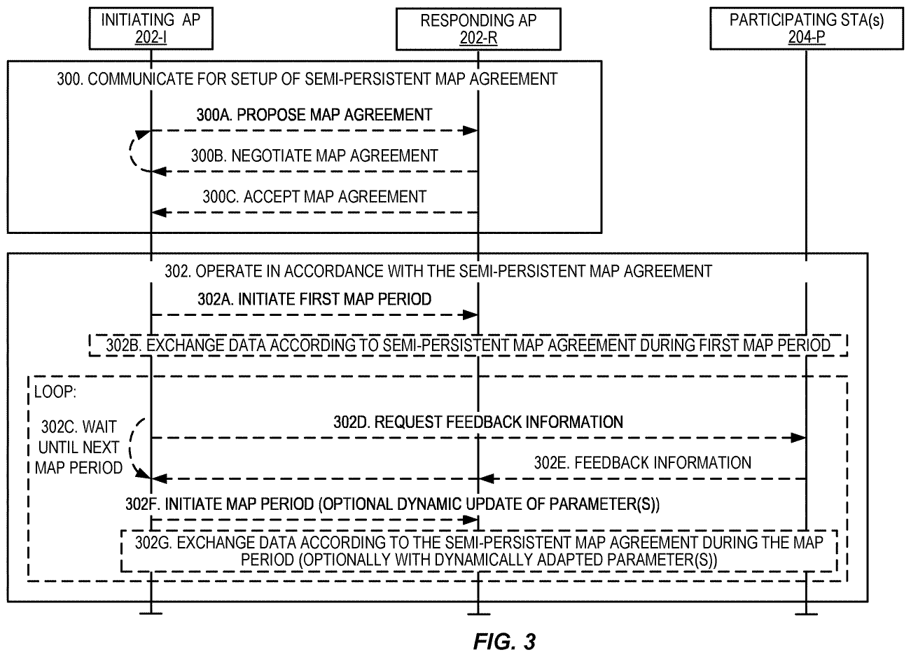

FIG. 3 illustrates the operation of a set of APs 202 to setup and operate in accordance with a semi-persistent MAP agreement in accordance with one embodiment of the present disclosure. Note that dashed lines/boxes represent optional steps. In this example, the procedure involves two APs 202, which are referred to as an initiating AP 202-I and a responding AP 202-R, and one or more STAs 204, which are referred to as participating STA(s) 204-P. Note that while the example of FIG. 3 includes a single responding AP 202-R, there may be any number of one or more responding APs 202-R that participate in setup and application of the semi-persistent MAP agreement. The initiating AP 202-I is, in this example, the AP 202 that initiates setup of the semi-persistent MAP agreement as well as initiates each MAP period; however, the present disclosure is not limited thereto. The MAP periods may, in some embodiments, be initiated by the responding AP 202-R. The responding AP 202-R is, in this example, an AP 202 that takes part in the initial setup of the semi-persistent MAP agreement 202-R; however, it should be noted that, in some embodiments, an additional AP(s) 202 may be invited to join the MAP agreement after initial setup of the semi-persistent MAP agreement, in which case the newly invited AP(s) 202 may or may not be able to negotiate changes to the semi-persistent MAP agreement when joining, depending on the particular embodiment.

As illustrated, the initiating AP 202-I and the responding AP 202-R communicate for setup of a semi-persistent MAP agreement (step 300). The semi-persistent MAP agreement defines multiple MAP periods during which coordinated MAP operation between the participating APs 202-I and 202-R may occur. In one embodiment, the MAP periods are independent from SPs for a TWT or r-TWT mechanism utilized by at least one of the participating APs 202-I and 202-R. In one embodiment, the coordinated MAP operation may include, e.g.:
operation to provide Coordinated Spatial Reuse (CSR), which coordinates transmit power between different APs such that spatial reuse can be achieved,
operation to provide coordinated beamforming where nulls are placed in directions that mitigate or eliminate interference at respective receivers,
operation to provide Coordinated Orthogonal Frequency Multiple Access (C-OFDMA) or Coordinated Time Division Multiple Access (C-TDMA), where frequency or time resources are divided among the participating APs 202-I and 202-P,
operation to provide synchronized transmission direction for the participating APs 202-I and 202-R,
operation to provide coordinated use of multi-links and/or channel assignments by the participating APs 202-I and 202-R;
operation to provide Cooperative-OFDMA where the participating APs 202-I and 202-R transmit to a same STA 204 but on different resources;
operation to provide coordinated joint transmission to a same STA 204;
operation to provide coordinated quiet intervals; or
operation to provide prioritization of specific data flows,

Note that the type of coordinated MAP operation may vary from one MAP period to another or be the same across the MAP periods.

As described herein, the semi-persistent MAP agreement may include various parameters such as, e.g., one or timing parameters (e.g., duration, periodicity, persistence length of the semi-persistent MAP agreement, or the like or any combination thereof) that define the MAP periods. The semi-persistent MAP agreement may include further information such as, e.g.: (i) information about whether a MAP period may be initiated only by the initiating AP 202-I, (ii) information about whether a MAP period may be initiated by any of the participating APs 202-I and 202-R, (iii) information about whether any information or parameters need to be collected or updated before or at a start of a MAP period, or (iv) a combination of any two or more of (i)-(iii).

In one embodiment, at least one of the MAP periods includes at least one (r-)TWT SP. In another embodiment, at least one of the MAP periods includes at least two (r-)TWT SPs. In this case, MAP coordination within such a MAP period may be based on prioritization between the SPs or the data belonging to the SPs. In one embodiment, the prioritization is based on which of the at least two SPs started first or which of the data belonging to the at least two SPs arrived first, which of the at least two SPs has a lowest duration or which of the at least two SPs for which the data has a lowest latency bound, or which of the at least two SPs has a least amount of time before it ends or which of the at least two APs for which the data has a least amount of time remaining until its latency bound.

In one embodiment, the semi-persistent MAP agreement may include one or more restrictions about how the semi-persistent MAP agreement or parameter(s) included therein can be dynamically updated.

In one embodiment, as part of the communication of step 300, the initiating AP 202-I sends a message(s) to the responding AP 202-R that proposes the semi-persistent MAP agreement (step 300A). In one embodiment, this message(s) includes the semi-persistent MAP agreement or an initial proposed version of the semi-persistent MAP agreement. Optionally, the responding AP 202-R sends a response to the initiating AP 202-I to negotiate one or more parameters of the semi-persistent MAP agreement (step 300B), in which case the process may then return to step 300A where the initiating AP 202-I sends a new proposed semi-persistent MAP agreement to the responding AP 202-R. This negotiation process may continue until an agreement has reached (or until some defined threshold for ending the negotiation has been reached). Assuming that the responding AP 202-R accepts the semi-persistent MAP agreement, the responding AP 202-R may send an acceptance message to the initiating AP 202-I (step 300C). Note that, in an alternative embodiment, no acceptance is sent from the responding AP 202-R to the initiating AP 202-I, and the initiating AP 202-I assumes that the responding AP 202-R has accepted the proposed or negotiated semi-persistent MAP agreement.

Optionally, before the start of the first MAP period, the initiating AP 202-I may request and receive feedback information from the STA 204-P (steps 301A and 301B). This feedback information may be optionally collected from each APs associated STAs in order to support the agreed upon coordination within the upcoming MAP period. The feedback information may be used by the initiating AP 202-I to decide how best to adapt the parameter(s) of the semi-persistent MAP agreement for the next MAP period. The feedback information may include measurement information such as, for example, measurements related to interference conditions, measurements related to traffic conditions, measured SINR values, and/or the like and/or other information such as, e.g., rank of the channel.

The APs 202-I and 202-R as well as the STA 204-P operate in accordance with the semi-persistent MAP agreement (step 302). More specifically, in this example, the initiating AP 202-I sends a message(s) to the responding AP 202-R that initiates a first MAP period of the semi-persistent MAP agreement (step 302A). This initiation may be an indication that the APs 202 are to actually use the MAP period and may optionally include one or more adapted parameters for the MAP period (e.g., an indication of a coordinated MAP technique to be used during the MAP period, an indication of a duration of the MAP period, or the like). The APs 202-I and 202-R and the STA(s) 204-P then exchange data (i.e., transmit and receive data) during the MAP period in accordance with the semi-persistent MAP agreement (step 302B). Note that the Aps 202-I and 202-R may communicate with different STAs 204-P or the same STA 204-P.

The following steps may then be repeated for each MAP period. The initiating AP 202-I waits until the next MAP period (step 302C). During the period of time between MAP periods, the initiating AP 202-I may request and receive feedback information from the STA 204-P (steps 302D and 302E). As discussed above in regard to steps 301A and 301B, this feedback information may be optionally collected from each APs associated STAs in order to support the agreed upon coordination within the upcoming MAP period. When the first/next MAP period has been reached, channel access is performed after which an initiating AP (e.g., the initiating AP 202-I) sends, to the responding AP 202-R, a message(s) that initiates the next MAP period (step 302F). This message(s) may include one or more updated, or adapted, parameters for the semi-persistent MAP agreement to be used in the initiated MAP period. The APs 202-I and 202-R and the STA 204-P then exchange data (i.e., transmit and receive data) during the MAP period in accordance with the semi-persistent MAP agreement (step 302G). The process then returns to step 302C and repeats.

Note that an additional AP(s) 202 may be added to the semi-persistent MAP agreement over time (i.e., after initial setup of step 300). The additional AP(s) 202 may be invited to join the semi-persistent MAP agreement and, in some embodiments, may be enabled to negotiate changes to the semi-persistent MAP agreement via steps similar to those 300A-300C. Also, there may be more than two APs 202 when the semi-persistent MAP agreement is initiated/setup.

The procedure of FIG. 3 may be realized in in different ways. Specifically, the following description will show how this procedure may work within the multi-AP framework as well as within the TWT framework.

### Multi-AP Related Embodiments

In one embodiment, the setup procedure (e.g., in step 300 of the procedure of FIG. 3) for the semi-persistent MAP agreement may look similar to that of previously disclosed multi-AP coordination except that additional information may also be signaled such as, e.g.:
Persistence Length: The persistence length is a duration of time over which the semi-persistent MAP agreement applies. Note that multiple MAP periods occur during the persistence length. The persistence length may be defined, e.g., in terms of:
   a number of beacon intervals;
   a number of coordination opportunities (e.g., a number of MAP periods); or
   an amount of time.
Periodicity, i.e., the time in between each MAP period.
Duration, i.e., the length of each MAP period. The duration cannot exceed a maximum length of a TXOP or a maximum PPDU length depending on which is relevant.
Specific information needed for subsequent MAP periods such as, e.g.:
   information that indicates which AP(s) 202 can initiate a MAP period (e.g., only the AP 202-I that initiated setup of the MAP agreement may initiate a MAP period or any cooperating AP 202 may initiate a MAP period); and/or
   information that indicates whether some information needs to be collected or refreshed before a MAP period.

Initial setup is performed by the initiating AP 202-I and may be performed in many different ways depending on the coordination scheme being employed. However, subsequent setup procedures may not need to be as extensive. Thus, there are options for the initiating AP 202-I when setting up such semi-persistent MAP agreements.

First, the initiating AP 202-I may either directly propose that a semi-persistent MAP agreement should be used (e.g., in step 300A of FIG. 3), or alternatively the initiating AP 202-I may ask for feedback from one or more responding APs before proposing a semi-persistent MAP agreement. Second, a subsequent MAP period (e.g., a MAP period other than the first MAP period) may be initiated by sending a re-setup message (e.g., in step 302F of FIG. 3) that may contain very little information and just acts as a trigger for all the responding APs 202-R that the MAP period has been initiated. Alternatively, one or more new parameters (e.g., one or more new transmit parameters such as, e.g., transmit power, allocated frequency band, allocated time interval, and/or the like, where different transmit parameters may be used for different transmission schemes) may be distributed that should be used for this particular MAP period or from this MAP period on. Moreover, an initiating AP may ask for feedback from the responding APs in the time window between MAP periods as well before redistributing new parameters. Finally, the re-setup may just contain a subset of information needed in the initial setup of the semi-persistent MAP agreement.

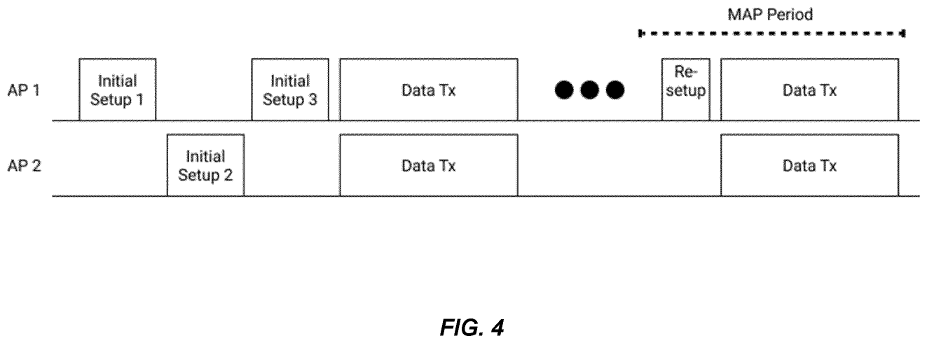

One example of semi persistent MAP coordination in accordance with an example semi-persistent MAP agreement is illustrated in FIG. 4. In FIG. 4, the initiating AP 202-I first initiates the setup procedure for the semi-persistent MAP agreement in Initial Setup 1 frame. For example, the initiating AP 202-I may send the proposed semi-persistent MAP agreement of step 300A of FIG. 3 in the Initial Setup 1 frame. The responding AP 202-R then answers with some feedback information in Initial Setup 2 frame. For example, the responding AP 202-R sends a message(s) in Initial Setup 2 frame proposing one or more changes to the semi-persistent agreement as part of the negotiation of step 300B of FIG. 3. The initiating AP 202-I then uses the information included in the Initial Setup 2 frame to assign parameters (e.g., Tx parameters) for the semi-persistent MAP agreement, and sends the updated semi-persistent MAP agreement or the new parameters for the semi-persistent MAP agreement in Initial Setup 3 frame (this may correspond to the second iteration of step 300A of FIG. 3 during negotiation). Thereafter, the APs 202-I and 202-R undertake their coordinated transmissions. Sometime later when the next MAP period is reached, the initiating AP 202-I initiates the MAP period by, in this example, triggering MAP coordination again. However, this time, the initiating AP 202-I only sends a shorter single message (Re-setup message) to confirm to the responding AP 202-R that coordination should be undertaken again and, optionally, including one or more updated parameters for the semi-persistent MAP agreement to be applied in the initiated MAP period (and possibly future MAP periods).

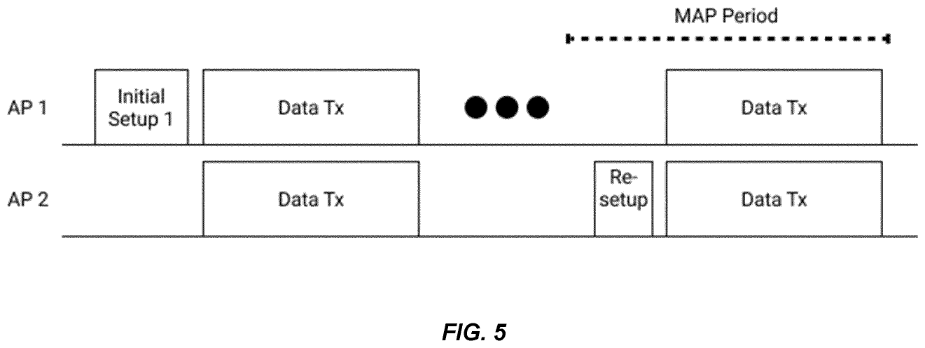

In one embodiment, channel access within the MAP period is performed according to the prevalent Listen-Before-Talk (LBT) mechanism. As such, there is no guarantee that access will be granted during this period. In this case the Re-Setup message serves also the purpose of AP 202-I informing AP 202-R that channel has now been reserved and operations as agreed can start. In another embodiment, the start of any subsequent MAP periods may be initiated by any AP, as shown in the example of FIG. 5. Thus, the likelihood of getting access to the channel faster is higher, which reduces latency. Whether or not this option should be allowed may be decided by the initiating AP 202-I in the initial setup of the semi-persistent MAP agreement.

In order to create conditions that could help delivering critical traffic within bounded delay in a scheduled MAP period, one can take advantage of the (r-)TWT framework.

### (r-)TWT Coordination Related Embodiments

In another embodiment, the MAP periods defined by the semi-persistent MAP agreement coincide with one or more (r-)TWT schedules for at least one of the coordinating APs 202. In other words, at least one of the MAP periods may include at least one (r-)TWT SP. It should be noted that while MAP periods are agreed between APs, each AP independently sets its (r-)TWT SP(s), i.e., in a MAP period different APs may have different numbers of (r-)TWT SPs, or an AP may not have an SP at all. Except for the coordination described in the preceding section, which may be performed in the semi-persistent MAP periods, these specific coinciding (r-)TWT SPs may have some additional specific parameters changed in order to better protect the data that is to be delivered within the SPs. Those parameters may, for example, include one or more of the following:
increased bandwidth for the r-TWT scheduling AP such that it may use more robust modulation and coding scheme (MCS) or repetitions etc.;
higher allowed Tx power;
increased guard bands;
specific direction of data flow, since, e.g., downlink interference is more predictable than uplink interference;
quiet periods.

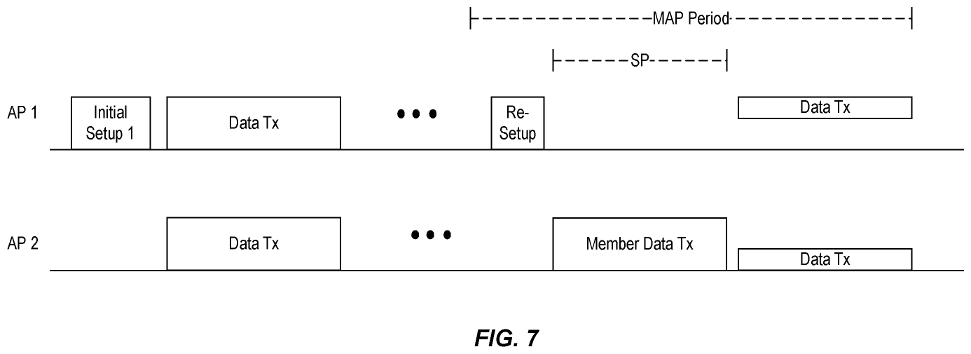

As such, a MAP period that includes at least one SP for at least one of the APs may either provide protection to the member data of the SP or use additional coordination, as described in the preceding section, to both satisfy the needs of the member data of the SP (i.e., the critical traffic to be transmitted within the SP) whilst still allowing a non-SP scheduling AP (i.e., an AP that has no scheduled SPs during the current MAP period) to also benefit from the coordination, which would increase the network performance, e.g. if the coordinating APs would use CBF to both operate simultaneously with minimal interference or split their frequency resources using C-OFDMA. Furthermore, the MAP period window could cover a larger time period than the SP requires and thus allow for different types of coordination inside the SP window and outside of it, as in for example FIG. 7.

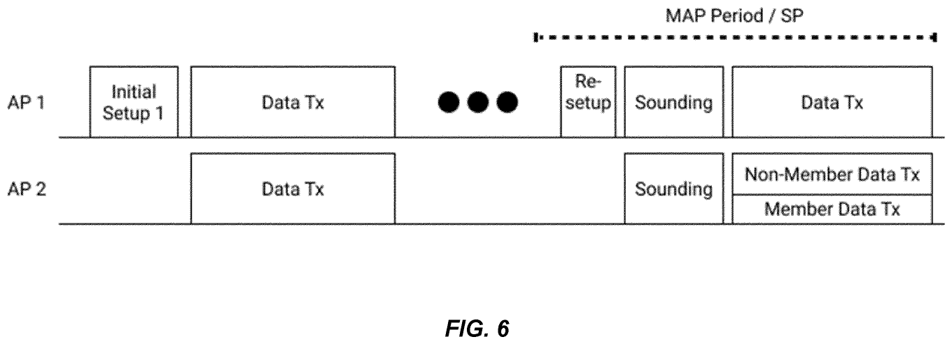

FIG. 6 illustrates example of initial setup of a semi-persistent MAP agreement and operation in accordance therewith within a MAP period when the MAP period completely coincides with a SP belonging the responding AP 202-R (shown as “AP 2” in FIG. 6). In this MAP period, the APs have agreed to coordinate their operation using CBF in order to null towards each other's target STAs (and therefore a Sounding phase is performed before the actual transmissions can start). AP 1 is using its resources to transmit to a single STA, whilst AP 2 has decided to split its resources into 1 Resource Unit (RU) towards the member STA of the SP and another part towards a non-member STA. In the following we refer with “Member Data TX” to the traffic that is to be transmitted and protected within an SP, and with “Non Member Data TX” as a traffic that is no necessarily to be transmitted within an SP. By using CBF, there is little to no interference at the receivers, and the APs can both take advantage of the multi-AP schemes available as well as provide sufficient protection for any member data of an (r-)TWT SP.

FIG. 7 illustrates an example of what the semi-persistent coordination may look like within a single MAP period when the MAP period covers more time than the SP has been set up for. In the example in FIG. 7 the SP period belongs to AP2 and is delimited with vertical gray lines in FIG. 7. In other words, in FIG. 7, a similar example of initial setup of a semi-persistent MAP agreement and operation in accordance therewith for a MAP period is shown, but in this example the MAP period has been set up for more time than the SP requires. This might be more suitable when the application traffic has deterministic arrival times (the Member Data Tx is scheduled immediately after the Re-Setup message is received) while the procedure in FIG. 6 might be more suitable when the traffic may have some inter arrival jitter (where the Member Data TX happens after the Sounding phase).

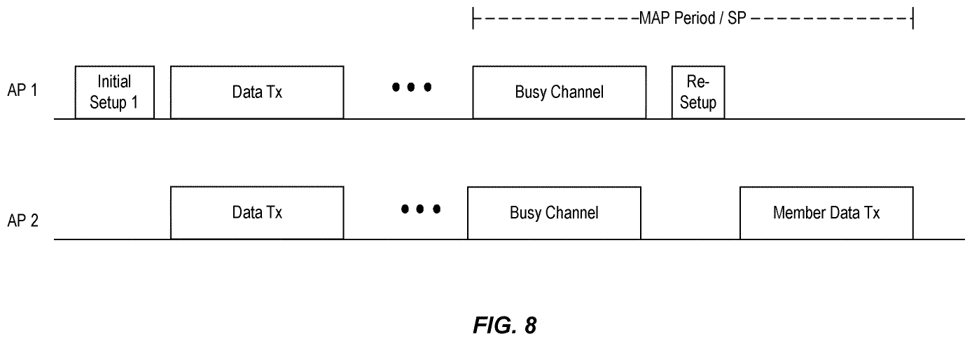

It may be so that the initiating AP does not get access to the medium at the start of the intended MAP period due to for example, the channel being busy/occupied. This may be particularly problematic in the cases when a MAP period coincides with a SP as there might be some time critical data that needs to be delivered within the MAP period and as such the initiating AP may need to re-prioritize whenever it gets to send the Re-setup Frame. One such example may be seen in FIG. 8, where the same scenario depicted in FIG. 6 is drawn (SP belongs to AP2) but due to the delayed channel access in the MAP period the initiating AP decides use all resources for Member Data TX only.

In yet another embodiment, a semi-persistent MAP period overlaps with two or more SPs scheduled by different TWT scheduling APs. Aside from the previous means of coordination, some specific ways the APs may coordinate in these cases include one or more of the following:
Prioritize a particular flow of data, this prioritization may either be based on
   which of the data flows arrived first in time,
   which of the data flows has a lower latency bound, or
   which of the data flows has the least time left until its latency bound;
Prioritize a particular SP, where this prioritization may be based on any of the following:
   which of the SPs occurs first in time,
   which of the SPs has a smaller duration,
   which of the SPs has the least amount of time left in its duration.
Split the SPs so they do not overlap in either time or frequency, this can be taken based on a cost of incurring latency in either service.

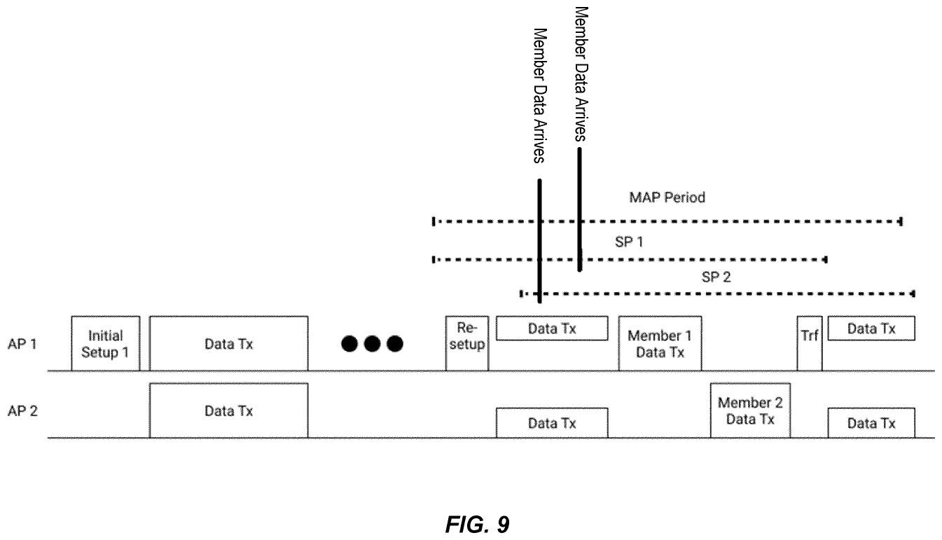

In FIG. 9, an example is shown where the MAP period agreed upon in the initial setup covers the duration of both a first SP (SP 1 that belongs to AP1) and a second SP (SP 2 that belongs to AP2). The agreement says that the APs should mix background data and the member data throughout the MAP period. As a part of the agreement, when transmitting background data, the APs use C-OFDMA. When transmitting the member data, only one AP (the AP with Member Data to transmit) at a time transmits. Furthermore, it is agreed that the member data of SP 1 should be always transmitted before the member data of SP 2.

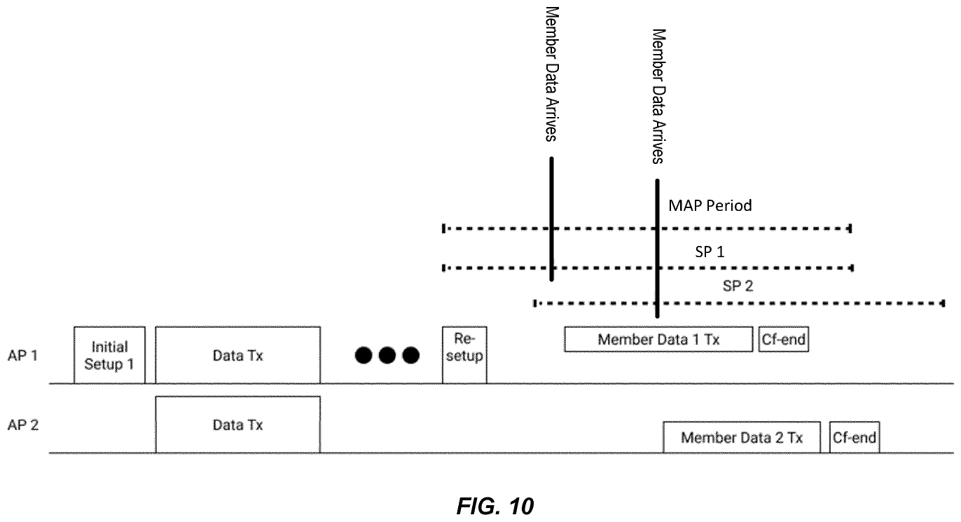

In FIG. 10, another example of a MAP period that covers two or more SPs from different coordinating APs and how this may be handled via the semi-persistent MAP agreement is shown. Here, the MAP period covers the first SP, SP1, as well as an overlap between the first SP and the second SP, SP2 (but not the last portion of the SP2). In this example, the semi-persistent MAP agreement is such that the APs have decided that they will not transmit any background data and that any member data will be transmitted on separate RUs using C-OFDMA. Furthermore, the re-setup signals a Quiet Interval in order to protect the SP until the first member data arrives. Optionally the RUs may be released by using a Contention-Free End (CF-end) frame if the transmissions finish before the end of the SP.

In some of the examples above, the TWT coordinated opportunities may be scheduled by using the same multi-AP framework envisioned to be used for other means of AP coordination, as in FIG. 6 through FIG. 10. In another embodiment, the coordination is already setup and agreed upon when the broadcast TWT scheduling takes place.

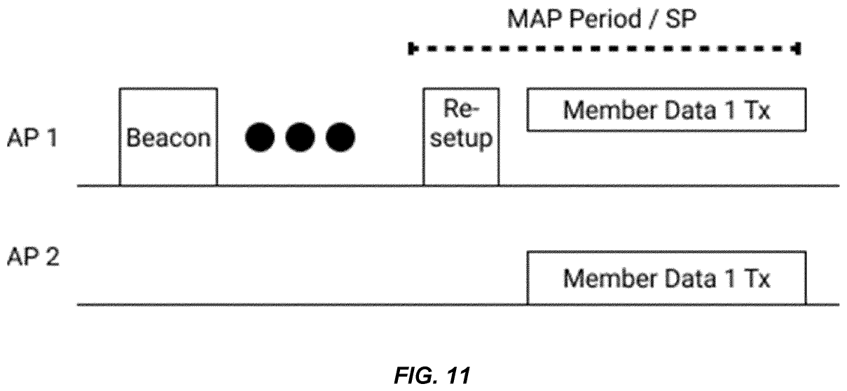

In one example embodiment, a TWT scheduling AP, at the same time as it broadcasts its TWT schedule, signals one or more timing or Tx parameters it is willing to share or negotiate with another cooperating AP. Those parameters may be the same as the previously described parameters used for coordination. As an example, consider FIG. 11. In FIG. 11, an AP 1 that sets up a broadcast TWT agreement in its beacon simultaneously indicates that AP 2 can join AP1 in performing cooperative OFDMA to provide better reliability. In this example, the re-setup frame may signal some additional information to AP 2 for performing cooperative OFDMA.

Re-Negotiating or Terminating Existing Agreements Additionally, in some embodiments, the initial setup procedure for the semi-persistent MAP agreement may be performed again, e.g., during the persistence length of the semi-persistent MAP agreement, if the initiating AP 202-I or the responding AP 202-R (or some later invited coordinating AP) desires to re-negotiate some aspects of the semi-persistent MAP agreement Furthermore, another option for minor renegotiation of operating parameters of the semi-persistent MAP agreement may be allowed in subsequent re-setup frames. How large these variations may be can, for example, be agreed upon in the initial setup of the semi-persistent MAP agreement. Alternatively, one or more out of the coordinating APs may decide to terminate an existing agreement.

There may be multiple reasons due to which an existing semi-persistent MAP agreement may need to be re-negotiated or terminated. Some examples are as follows:
Change of Quality of Service (QOS) requirements in one or more coordinating APs' Basic Service Sets (BSSs) making communication with existing agreement unfavorable,
Change of traffic load in one or more coordinating APs' BSSs making communication with existing agreement unfavorable,
Change of number of devices to be served in one or more coordinating APs' BSSs making communication with existing agreement unfavorable,
Change of quality of wireless medium in one or more coordinating APs' BSSs making communication with existing agreement unfavorable,
Change of interference situation in one or more coordinating APs' BSSs making communication with existing agreement unfavorable,
Change of number of APs that may participate in coordination during MAP periods, due to for example, new APs becoming active and wanting to join in the coordination,
Change of need of coordination for one or more coordinating APs, thereby removing the need of multi-AP coordination for that AP(s), resulting in the breaking down of existing agreements if any.

### Further Description of AP and STA Architectures

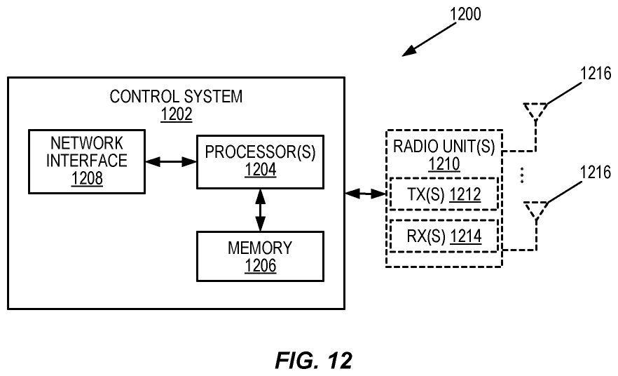

FIG. 12 is a schematic block diagram of an AP 1200 according to some embodiments of the present disclosure. Optional features are represented by dashed boxes. The AP 1200 may be, for example, any of the cooperating APs 202 described above. As illustrated, the AP 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the AP 1200 may include one or more radio units 1210 that each includes one or more transmitters 1212 and one or more receivers 1214 coupled to one or more antennas 1216. The radio units 1210 may be referred to or be part of radio interface circuitry. The one or more processors 1204 operate to provide one or more functions of the AP 1200 as described herein (e.g., one or more functions of an AP 202, initiating AP 202-I, or responding AP 202-R as described herein). In some embodiments, the function(s) are implemented in software that is stored, e.g., in the memory 1206 and executed by the one or more processors 1204.

In some embodiments, a computer program including instructions which, when executed by at least one processor, causes the at least one processor to carry out the functionality of radio access node 1200 or a node (e.g., a processing node) implementing one or more of the functions of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a first wireless Local Area Network (WLAN)-WLAN, Access Point (AP); AP, comprising:
communicating with at least one second WLAN AP for setup of a semi-persistent multi-AP (MAP) agreement that defines a plurality of MAP periods in which coordinated MAP operation between the first WLAN AP and the at least one second WLAN AP is to occur; and
operating in accordance with the semi-persistent MAP agreement;
wherein both the first WLAN AP and the at least one second WLAN AP are permitted to transmit during each of the plurality of MAP periods in accordance with the semi-persistent MAP agreement.

2. The method of claim 1 wherein the plurality of MAP periods are independent from Service Periods (SPs) for a Target Wake Time (TWD) or restricted TWT (r-TWD) mechanism utilized by at least one of the first WLAN AP and the at least one second WLAN AP.

3. The method of claim 1, wherein the coordinated MAP operation comprises:
operation to provide Coordinated Spatial Reuse (CSR) which coordinates transmit power between different APs such that spatial reuse can be achieved;
operation to provide coordinated beamforming where nulls are placed in directions that mitigate or eliminate interference at respective receivers;
operation to provide Coordinated Orthogonal Frequency Multiple Access (C-OFDMA) or Coordinated Time Division Multiple Access (C-TDMA), where frequency or time resources are divided among the first WLAN AP and the at least one second WLAN AP;
operation to provide synchronized transmission direction for the first WLAN AP and the at least one second WLAN AP;
operation to provide coordinated use of at least one of multi-links and channel assignments by the first WLAN AP and the at least one second WLAN AP;
operation to provide Cooperative-OFDMA where the first WLAN AP and the at least one second WLAN AP transmit to a same wireless station (STA) but on different resources;
operation to provide coordinated joint transmission to a same wireless STA;
operation to provide coordinated quiet intervals; or
operation to provide prioritization of specific data flows.

4. The method of claim 1, wherein a type of coordinated MAP operation in one MAP period of the plurality of MAP periods is different than a type of coordinated MAP operation in another MAP period of the plurality of MAP periods.

5. The method of claim 1, wherein communicating with the at least one second WLAN AP for setup of the semi-persistent MAP agreement comprises transmitting the MAP agreement to the at least one second WLAN AP.

6. (canceled)

7. The method of claim 1, wherein communicating with the at least one second WLAN AP for setup of the semi-persistent MAP agreement comprises:
transmitting and receiving messages to and from the at least one second WLAN AP for negotiation of the MAP agreement; and
receiving an acceptance of the MAP agreement, as negotiated by the messages.

8. The method of claim 1, wherein the plurality of MAP periods defined by the semi-persistent MAP agreement are periodic.

9. The method of claim 1, wherein the semi-persistent MAP agreement comprises one or more timing parameters that define timing of the plurality of MAP periods.

10. (canceled)

11. The method of claim 1, wherein the semi-persistent MAP agreement further comprises: (i) information about whether a MAP period may be initiated only by an initiating AP that initiated setup of the semi-persistent MAP agreement where the initiating AP is an AP from among the first WLAN AP and the at least one second WLAN AP, (ii) information about whether a MAP period may be initiated by any of the first WLAN AP and the at least one second WLAN AP, (iii) information about whether any information or parameters need to be collected or updated before or at a start of a MAP period, or (iv) a combination of any two or more of (i)-(iii).

12. The method of 1, wherein at least one of the plurality of MAP periods comprises at least one Service Period (SP) for a Target Wake Time (TWT) or restricted TWT (r-TWD) feature.

13. The method of claim 1, wherein at least one of the plurality of MAP periods comprises at least two Service Periods (SP) for a Target Wake Time (TWT) or restricted TWT (r-TWT) feature.

14. The method of claim 13, wherein the MAP coordination within the at least one of the plurality of MAP periods is based on prioritization between the at least two SPs or prioritization of data belonging to the at least two SPs.

15. The method of claim 14, wherein the prioritization is based on which of the at least two SPs started first or which of the data belonging to the at least two SPs arrived first, which of the at least two SPs has a lowest duration or which of the at least two SPs for which the data has a lowest latency bound, or which of the at least two SPs has a least amount of time before it ends or which of the at least two APs for which the data has a least amount of time remaining until its latency bound.

16. The method of claim 12, wherein at least one parameter defined by the semi-persistent MAP agreement is changed within an overlapping SP but not during the complete corresponding MAP period.

17. The method of claim 12, wherein communicating with the at least one second WLAN AP for setup of the semi-persistent MAP agreement comprises communicating with the at least one second WLAN AP for setup of the semi-persistent MAP agreement via a broadcast TWT agreement framework.

18. The method of claim 1, further comprising further communicating with the at least one second WLAN AP about initiation of a MAP period from among the plurality of MAP periods.

19. The method of claim 18, wherein further communicating with the at least one second WLAN AP about initiation of the MAP period comprises dynamically adapting at least one parameter of the semi-persistent MAP agreement for the initiated MAP period.

20. The method of claim 19, wherein one or more restrictions on the dynamically adapting are defined in the semi-persistent MAP agreement.

21.-22. (canceled)

23. The method of claim 1, wherein initiation of the MAP coordination within a MAP period is signaled by one of the first and at least one second WLAN APs.

24.-25. (canceled)

26. A first wireless Local Area Network (WLAN) Access Point (AP) comprising:
one or more transmitters;
one or more receivers; and
processing circuitry associated with the one or more transmitters and the one or more receivers the processing circuitry configured to cause the first WLAN AP to:
communicate with at least one second WLAN AP for setup of a semi-persistent multi-AP (MAP) agreement that defines a plurality of MAP periods in which coordinated MAP operation between the first WLAN AP and the at least one second WLAN AP is to occur; and
operate in accordance with the semi-persistent MAP agreement;
wherein both the first WLAN AP and the at least one second WLAN AP are both permitted to transmit during each of the plurality of MAP periods in accordance with the semi-persistent MAP agreement.

27. (canceled)
